(19) United States
(12) Patent Application Publication
(10) Pub. No.: US 2003/0054836 A1
(43) Pub. Date: Mar. 20, 2003

(54) Method and device for time control of movement or position of persons, animals or objects

(76) Inventor: Gerard Michot, Dampierre (FR)

Correspondence Address: William Drucker, Suite 800, 1901 L Street NW, Washington, DC, 20036, US

(21) Appl. No.: 10/168,127

(22) PCT Filed: Dec. 18, 2000
(86) PCT No.: PCT/FR00/03582

(30) Foreign Application Priority Data
Dec. 20, 1999 (FR) 99/16306

(51) Int. Cl. H04Q 7/20

(52) U.S. Cl. 455/456

(57) ABSTRACT

The invention concerns a method comprising the following successive steps: reading with a reading device (31) data stored by an identifying transponder chip (10), and transmitting the read data to a mobile telephone (20) whereto the reading device is connected, transmitting by mobile telephone to a control centre (1) a signalling message containing the data read by the reading device, reception at the control centre of the signalling message, and storing the data contained in the message received associated with data identifying the signalling message transmitter, and the time and date at which said message is received.

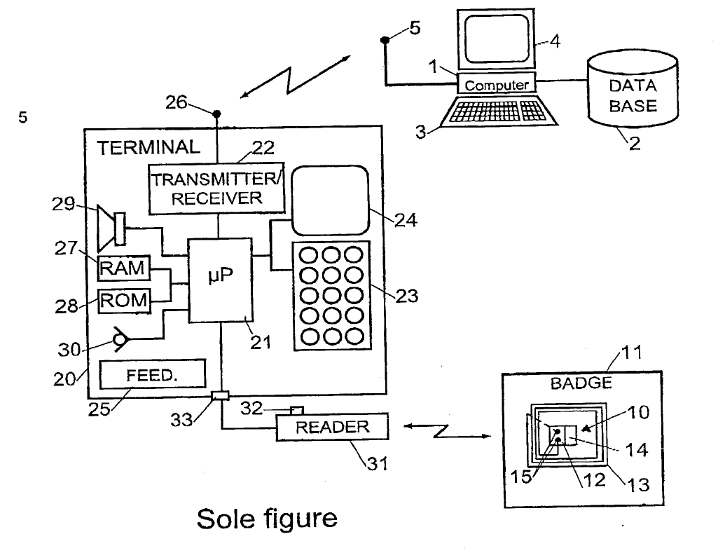

The present invention relates to a method and device for time-controlling the movement or position of persons, animals or objects.

It applies in particular, but not exclusively, to the time-control of the work of persons having several working sites, such as office maintenance personnel or persons providing home help. It can also be applied to monitoring the movements of a fleet of vehicles between several dumping sites, as well control of the parking period of vehicles.

At the current moment, there are devices for controlling the working hours of company employees. This device includes an identification badge reader and a clock device, each employee being provided with an identification badge read by the device on entering and leaving the work site so as to calculate and memorise the time the employee spent at his work location. It proves that this solution is unsuitable for employees who regularly change their work location as this would require that all the places of work in question be equipped with compatible time-control devices or when the employee is provided with a number of badges to correspond with the time control devices. In addition, the work time information memorised by the various time-control devices needs to be transmitted to a management centre in a given format which is not the case if the control devices are incompatible,

Another solution consists of providing the badge with memorisation means so that all the time information is transmitted by the time-control devices and memorised by the badge. This solution again requires that all the time-control devices are compatible with one another.

Furthermore, it has been suggested equipping domestic assistants providing medical or household assistance with a portable terminal including an identification badge reader, each person receiving this assistance being provided with an identification badge. At the start and end of each visit, the assistant using his terminal shall read the identification badge of the person visited so as to enable the terminal to memorise the corresponding hours and the identification information of the person visited, In addition, the assistant has a remote-transmission device including a modem for reading the time information memorised by the terminal and transmit this information via telephone to a management centre.

This solution is expensive as it requires that a specific terminal be given to each assistant as well as a remote transmission device which may need to be shared amongst several assistants.

The aim of the present invention is to eliminate these drawbacks To this effect, it concerns a method for the time-control of the movement or position of objects or persons.

According to the invention, this method is characterised in that it includes the following successive stages.

reading by a reading device of information memorised by an identification transponder chip and the transmission of the information read to a mobile telephone connected to the reading device,

transmission by the mobile telephone to a control centre of a signalling message containing the information read by the reading device,

the receiving by the control centre of the signalling message and the memorisation of the information contained in the received message in association with the identification information of the sender of the signalling message and the date and hour of receiving this message.

By means of these arrangements, the invention is able to report a control centre of an event linked to an identification code. This can be easily effected by connecting a mobile telephone, such as a GSM telephone, to a transponder chip reader which is small and inexpensive compatible with that of a mobile telephone, this connection being effected by using the connector provided on mobile telephones so as to connect a computer or peripheral elements such as a “free hands” kit. In this case, the chip reader can be activated with the aid of a control button provided on the box of the reader which triggers the reading of a chip and the transmission of the information read to the mobile telephone. The receiving of the information derived from the reader by the mobile telephone triggers the sending of the read information to an addressee whose telephone number has previously been introduced.

Alternatively, the chip reader can be triggered using a key or by means of control selection menus provided in the mobile telephone which requires a modification of the control programme of said telephone. It is also possible to integrate the chip reader in the box of the mobile telephone.

According to one particular characteristic of the invention, the transmission of the information read in the chip is effected in the from of a short mobile telephone message, thus rendering the cost of telecommunications using the device of the invention negligible.

So as to increase reliability of the system, it is possible for the control centre receiving the message to send back an acknowledgement message and have the mobile telephone inform the user that the acknowledgement message has been received.

In an application, such as working time control, the control centre also calculates the time elapsed between the receiving of two signalling messages transmitted by a given caller and containing the same identification code.

The invention also concerns a device for implementing the method.

According to the invention, this device is characterised in that it includes a transponder chip memorising identification information and a mobile telephone including a transponder chip reading device designed for reading the identification information memorised by the chip, and means to trigger reading by the reading device of information memorised by a chip an:d the radio transmission of a message containing the information read to a control centre.

Advantageously, the transponder chip is a no contact type, that is one induction-fed by the reading device and communicates with the latter by this means.

According to another particular characteristic of the invention, the transponder chip includes memorisation means accessible on reading and writing so as to be able to memorise information, especially the information received by the mobile telephone and transmitted by the reading device, such as an identification code.

In this case, the method of the invention could include legal loading stages enabling for example the user to gain access into protected sites, using devices under certain conditions, carrying out paying activities, having available a credit so as to be able to use paying services (telephone).

In a case where the memory contains information relating to a credit which is decremented gradually on using the function authorised by the chip, the management of this credit could be ensured by an outside account management body, such as a bank.

Of course, in this case the method shall implement security procedures with encryption of information transmitted to the chip so as to load it into the memory and decrypting this information when read by the reader.

One embodiment of the method and device of the invention shall be described hereafter given by way of non-restrictive example with reference to the accompanying drawing in which the sole FIGURE shows extremely diagrammatically a device for implementing the method of the invention.

This figure shows the device of the invention including a mobile telephone 20, such as a GSM type telephone, designed to carry out telephone communications with other mobile telephones or with telephones connected to a switched public telephone network.

This telephone conventionally includes a display screen 24 such as a liquid crystal type screen, a control keyboard 23, a receiver/transmitter device 22 connected to an antenna 26 for establishing a radio communication with a base station of a cellular radio network, a microphone 30 and a loud-speaker 29, all of these elements being controlled by a microprocessor 21 and fed with electric energy by a feed circuit 25 connected to a battery. The processor 21 is controlled by a programme stored in a read-only memory 28 and uses a read-write memory 27 for memorising in particular the operating parameters of the telephone.

According to the invention, connection means 33 provided on the mobile telephone are used to connect a computer or “free hands” kit for connecting to the processor 21 a transponder chip reading device 31 designed to this effect

This reading device is able to read the information recorded in a transponder chip 10, such as a no-contact type chip, including memorisation means 14 storing foolproof identification information of the chip, and transmission means 12 connected by connection terminals 15 to an antenna 13 These transmission means have been designed so as to read the information stored in the memorisation means 14 and transmit it onto the antenna 13.. The antenna 13 is made up of a set of spires enabling the chip to communicate via induction with a reading device which is also fed by this element.

Both the chip 10 and the antenna 13 can be integrated in a support 11, such as an identification badge, and both can be associated with a person, an animal, an object or even a place.

The reading device 31 is activated by the processor 21 following the user acting on the button 32 provided on the box of the reading device 31

This action triggers transmission via induction of the electric energy required for functioning of a transponder chip 10. When the chip 10 is activated, the transmission means 12 read the information contained in the memorisation means 14 and transmit this information to the reading device 31 in a modulated form. The reading device receives this information and demodulates it before sending it to the processor 21.

The processor 21 then puts this information in the form of a numerical signalling message and sends the message to a correspondent identified by a telephone number with the aid of the transmitter/receiver 22. The telephone number of the correspondent can be memorised as a parameter in the memory 27 or demanded from the user by means of the screen 24.

Alternatively, the reading device 31 is activated by pressing a key of the keyboard 23 provided to this effect or by means of a selection menu displayed on the screen 24.

Of course, the reading device 31 can also be integrated in the box of the mobile telephone 20.

According to the invention, the correspondent of the signalling messages is a control centre connected directly to the radio network by means of an antenna 5 or by means of the switched public telephone network. The control centre includes a computer 1 designed to directly receive the numerical signalling messages and store them in a database 2. This computer can also be connected to a control clement 3, such as a keyboard, and to a display screen 4.

When it receives a signalling message, the computer 1 recovers the information contained in the received message, as well as the identification information of the sender of the message and memorises this information in association with the current date and hour in the database 2,

To this effect, the data base can be organised at the rate of a, set of information per user identification code having a mobile telephone according to the invention, all the signalling messages sent by the user being marked and dated in this set.

The identification information of the sender of the message can be made up of the telephone number of the calling telephone 20 which can be recovered by the computer 1 at the time of the telephone transmission of the signalling message. Alternatively, this identification information can be demanded from the user or read in the memory 27 and inserted in the signalling message by the processor 21.

In particular, in one application for controlling the attendance time in a location, the device described above is intended to be used to transmit a first signalling message when the user arrives at a specific location, and a second signalling message when the user leaves this location. As a result, the computer 1 anticipates receiving two successive signalling messages containing the same chip identification information derived from the same sender

Accordingly, each time it receives a signalling message, the processor 21 determines whether it is a first or second signalling message via an access to the data base 2 so as to find out if a first message is already stored in the data base. If it is the second signalling message, the processor 21 calculates the period lapsed between the respective times of receiving the first and second messages and memorises this period in the database 2.

Of course, the device described above can also be used when it is 10 desired to simply time stamp the movement of a person or vehicle into a specific location, In this case, the transponder chip is attached to this location.

So as to make the transmission reliable between the telephone 20 and the computer 1, it is possible to provide that the computer 1 sends back an acknowledgement message each time it receives a signalling message, the receiving of this acknowledgement message being signalled on the screen 24 by the processor 21.

Advantageously, the transmissions between the telephone 20 and the computer 1 are effected in the form of numerical data transmission messages, such as those provided in the CSM standard. According to this standard, various data transmission methods are currently available, such as the SMS (Short Message Service), the HSCSD (High Speed Circuit Switched Data) and the GPRS (General Packet Radio Services). It is also possible to ensure that the communications between the mobile telephone 20 and the computer can be effected according to the new access protocol on the Internet network adapted to mobile telephones known as WAP (Wireless Application Protocol).

According to one particular characteristic of the invention, the memorisation means 14 of the transponder chips 10 are accessible on reading and writing and the reading device 31 has also been designed to transmit information to be entered in the memorisation means 14 of the chip during reading.

Thus, in an optical control reading, the processor 21 can send the date and current hour to the chip 10 during reading, as well as the called telephone number so as to transmit the corresponding signalling message. In this way, another person authorised to carry out controls can check by consulting a chip reading device that a first signalling message has been transmitted.

The method and device described above can be used in a large number of applications.

First of all, they can be used by persons having several work locations, such as home assistants used by social security bodies, for controlling their working time.

In this application, the assistants have available a mobile telephone provided with a smart card reader according to the invention, whereas persons benefiting from this assistance wear a badge integrating a transponder chip memorising an identification code of the person, said code being known at the control centre. The transponder chip can also be installed fixed at a location provided for this effect on each working site.

When he arrives and leaves the home of a person, the assistant triggers reading via his mobile telephone of the transponder chip of said person. In this way, the control centre is notified in real time where each assistant is located namely in the home of the person receiving assistance and can determine the working time of each assistant. This arrangement also enables the control centre to check by telephoning a person benefiting from assistance to find out that an assistant is at his premises at this particular moment

The method and device of the invention can also be applied for following up the use of a fleet of vehicles by installing a transponder chip in each vehicle memorising an identification code of the vehicle, each user having available a mobile telephone according to the invention so as to notify in real time a control centre that he has borrowed or taken a specific vehicle on a given date. It is also possible to associate a transponder chip with each parking site, this chip needing to be read by a user when he takes his vehicle which results in the transmission of a signalling message containing a site identification code so that the control knows in real time the parking site of each vehicle of the fleet and the date on which said vehicle was restored.

The method and device of the invention can also be applied for controlling the parking of vehicles and to the payment of the parking period.. To this effect, each vehicle or user or even each parking site shall be equipped with an identification transponder chip whose number is known by a control and billing centre. At the start and end of parking, the user triggers reading of the transponder chip with the aid of his mobile telephone, the information being transmitted by the mobile telephone of the invention to a management centre whose telephone number has been introduced by the user. With the aid of the transmitted information, the management centre calculates the period of parking and the corresponding amount to be paid and sends the billing of these amounts to the corresponding users.

It is then possible to provide control terminals for determining if a vehicle (motor vehicle or pleasure boat) parked has been properly declared to the management centre, these terminals comprising transponder chip reading means and possibly transmission means to interrogate the management centre. Alternatively, if the chip is accessible on reading and writing, the chip can memorise the date on which the last reading was carried out and the called management centre number.

In the case where the parking site is identified by a transponder chip, it is possible to provide that the user shall be previously introduced and recorded in his mobile telephone an identification code of his vehicle, such as the registration number of said vehicle. In this case, control is simply effected by contacting the management centre to find out if a parked vehicle has been previously recorded.

Generally speaking, the method and device of the invention can be applied to the management of a park of vehicles or mobile objects, such as rubbish skips placed at the disposal of subscribers per location.

1. Method for time-controlling the movement of objects or persons, characterised in that it includes the following successive stages.
reading by a reading/writing device (31) of information memorised by an identification transponder chip (10) and the transmission of the information read to a mobile telephone (20) connected to the reading device,
transmission by the mobile telephone to a control centre (1) of a signalling message containing the information read by the reading device,
the receiving by the control centre of the signalling message and the memorisation of the information contained in the received message in association with the identification information of the sender of the signalling message,
the sending back by the control centre (1) to the mobile telephone (20) of an acknowledgement message,
the writing in the transponder chip by the reading/writing device of information received by the mobile telephone.

2. Method according to claim 1, characterised in that said memorisation of the information contained in the received message is carried out in association with identification information of the sender of the signalling message and the date and hour of receiving this message.

3. Method according to claim 1 or 2, characterised in that said information received by the mobile telephone includes an identification code

4. Method according to claim 1, characterised in that the transmission of the information read in the chip is carried out in the form of a short message.

5. Method according to one of the preceding claims, characterised in that the identification information of the sender of the signalling message includes the telephone number of the mobile telephone (20) of the sender and is recovered by the control centre (1) when the latter receives the sign,a message.

6. Method according to one of the preceding claims, characterised in that on receiving of a signalling message transmitted by a mobile telephone (20), the control centre (1) sends back to the transmitting mobile telephone an acknowledgement message and the transmitting mobile telephone indicates on its display screen that an acknowledgement message has been received.

7. Method according to one of the preceding claims, characterised in that the control centre (1) calculates the time elapsed between receiving two signalling messages transmitted by a given mobile telephone and containing the same identification code.

8. Device for time-controlling the movement of objects or persons, characterised in that it includes a transponder chip (10) memorising identification information and a mobile telephone (20) connected to a transponder chip reading device (31) designed so as to read tie identification information memorised by the chip, and means (32) to trigger reading by the reading device of information memorised by a chip and the radio transmission of a message containing the read information to a control centre (1).

9. Device according to claim 8, characterised in that the transponder chip (10) is a no-contact type chip.

10. Device according to claim 8 or 9, characterised in that the transponder chip (10) comprises memorisation means (14) accessible both on writing and reading so as to be able to memorise the information received by the mobile telephone (20) and which is transmitted to it by the reading device (31).

11. Device according to one of claims 8 to 10, characterised in that the chip reading device (31) has been designed so as to be connected to the connector (33) provided on the mobile telephones so as to connect a computer or peripheral elements, the chip reading device (31) being activated with the aid of a control button (32) provided on the box of the reader which triggers the reading from a chip (10) and the transmission of the read information to the mobile telephone (20).

12. Device according to one of claims 8 to 10, characterised in that the chip reading device (31) is integrated in the box of the mobile telephone (20) and is triggered with the aid of a key (23) or by means of control selection menus provided in the mobile telephone.
